(19) United States
(12) Patent Application Publication
(10) Pub. No.: US 2001/0010491 A1
(43) Pub. Date: Aug. 2, 2001

(54) Signal discriminator for wake-up of a low power transponder

(76) Inventors: Willem J. Marneweck, Gilbert, AZ (US); Johannes Albertus Van Niekerk, Tempe, AZ (US)

Correspondence Address: BAKER BOTTS, LLP, 910 LOUISIANA, HOUSTON, TX, 77002-4995, US

(21) Appl. No.: 09/799,287

(22) Filed: Mar. 5, 2001

Related U.S. Application Data
(63) Continuation-in-part of application No. 09/432,907, filed on Nov. 2, 1999.

(51) Int. Cl. H04Q 5/22; H04B 1/16

(52) U.S. Cl. 340/10.33; 455/343

(57) ABSTRACT

A signal discriminator for preventing activation by undesired signals of low power transponder circuits in a keyless entry system. These undesired signals may be noise or interfering signals. An asymmetrical low pass filter is used to determine the presence of a desired signal having a defined length of time. The asymmetrical filter has a longer charge time then discharge time, thereby being adapted to quickly discharge upon the loss of a signal. Signal duration verification is further used to determine if the desired signal is of a correct time duration.

### RELATED PATENT APPLICATION

This application is a continuation-in-part of commonly owned U.S. patent application Ser. No. 09/432,907, filed Nov. 2, 1999, entitled “Passive Signal Discriminator for Wake-Up of Low Power Transponder” by Marneweck et al., hereby incorporated reference for all purposes.

### FIELD OF THE INVENTION

This invention relates generally to a keyless entry systems, and more particularly to preventing unnecessary wake-up of dormant power circuits in the keyless entry systems.

### BACKGROUND OF THE RELATED TECHNOLOGY

Radio Frequency Identification (RFID) systems use radio frequencies and/or magnetic fields to identify, locate and track people, assets, and animals. The RFID systems are also used in keyless security and entry systems. Vehicular applications include remote keyless entry, alarm systems and immobilizers for cars and trucks. Consumer applications include car alarms, garage door openers, burglar alarms, gate locks, door locks and the like. In remote keyless entry systems, a transponder is activated when an interrogation signal (challenge) is received. The interrogation signal may be a time-varying electromagnetic radio frequency (RF) signal that is transmitted by a keyless entry system reader such as a microprocessor and radio frequency generator/modulator. The transponder, upon activation, responds to the interrogation challenge (bi-directional authentication). Generally, the keyless entry system transponder is embedded in a key fob, or even the key, and is powered from a small battery integral therewith. It is desirable and at times imperative that the power of this small battery be conserved.

An effective way of conserving battery power is to turn off, i.e., disconnect the electronic circuits of the transponder and any associated circuitry not required in detecting the presence of an electromagnetic RF signal (interrogation challenge) from the keyless entry system reader. Only when the interrogation signal is detected, are the electronic circuits of the transponder reconnected to the battery power source (wake-up). A problem exists, however, when the transponder receiver is exposed to noise sources such as electromagnetic radiation (EMR) emanating from, for example, televisions and computer monitors having the same frequency as the interrogation signal, the transponder will wake-up unnecessarily. If the transponder receiver is exposed to a continuous noise source, the battery may be depleted within a few days.

Therefore, what is needed is a system, method and apparatus for preventing wakeup of the transponder circuits by undesired noise signals.

### SUMMARY OF THE INVENTION

The invention overcomes the above-identified problems as well as other shortcomings and deficiencies of existing technologies by providing a low pass filter circuit that requires a wake-up signal to be present for a desired length of time. The low pass filter may be passive (draws no power from the battery) or active.

Noise signals will typically not have enough radio frequency electromagnetic energy over the desired length of time to exceed the wake-up time threshold of the low pass filter. In the event that the noise signals do have enough radio frequency electromagnetic energy over the desired length of time to exceed the wake-up time threshold of the low pass filter, then another embodiment of the invention has a signal duration timer. This signal duration timer prevents the wake-up signal from actuating. In this embodiment a desired interrogation signal must be on for at least a first time but no longer than a second time. If these two conditions are met, then the transponder will wake-up and the next interrogation signal will be processed.

In accordance with an embodiment of the present invention, an asymmetrical time constant low pass filter comprises a resistor in parallel with a diode, both being connected to a capacitor. The resistor and diode are in series with the signal path from the low frequency interrogation receiver to the transponder wake-up circuit. The capacitor is connected in parallel with the input of the transponder wake-up circuit and ground or signal common. When a signal is received by the interrogation receiver, be it an actual interrogation signal or an undesired interference or noise signal, the capacitor begins charging to a desired voltage level. The charging time constant is determined by the combination of the resistor and capacitor values according to the formula: τ=RC, where τ is the time constant, R is the resistance is ohms and C is the capacitance in farads.

A desired interrogation signal will maintain enough signal energy over a desired time period for the charging voltage across the capacitor to reach the desired voltage level (hereinafter “wake-up threshold voltage”). Once the wake-up threshold voltage is reached, the transponder circuits wake-up and a response to the challenge is sent by the transponder. An undesired interference or noise signal will charge the capacitor for a time period less than the desired time period and when the undesired noise signal energy is not sufficient or present to continue charging the capacitor, the diode in parallel with the resistor will quickly discharge the capacitor. Thus, the voltage across the capacitor will slowly build up so long as a signal having energy at a desired frequency is being received, but if that signal energy drops, then the voltage charge across the capacitor is quickly bleed off through the diode. In this way the wake-up circuit of the transponder is exposed to far less false triggering and thus causes less unnecessary drain on the battery power supply. Any interruption of a detected signal will quickly reset the voltage charge on the capacitor, and if the wake-up threshold voltage is not yet reached, then transponder circuits will not be connected to the battery power supply.

A feature of the present invention is preventing the connection of (waking up) power consuming circuits to a battery power source in the presence of noise signals.

Another feature of the present invention is a passive low pass filter which consumes no power from the battery power source.

Still another feature is an asymmetrical time constant low pass filter which requires signal energy to be present for a desired time period for charging a capacitor to a wake-up threshold, and quickly discharges the capacitor if the signal energy is not present.

Another feature is requiring an interrogation signal to be present for at least a first time but no longer than a second time before a wake-up signal is generated.

An advantage of the present invention is reducing the occurrence of the false triggering of a wake-up action on dormant electronic circuits.

Another advantage is reducing unnecessary power consumption from a battery power source.

Still another advantage is increased battery operating time due to better defined wake-up criteria.

Features and advantages of the invention will be apparent from the following description of presently preferred embodiments, given for the purpose of disclosure and taken in conjunction with the accompanying drawings.

### BRIEF DESCRIPTION OF THE DRAWINGS

FIG. 1 is schematic block diagram of a keyless entry system according to an embodiment of the invention;

FIG. 2 is schematic block diagram of a keyless entry system according to another embodiment of the invention;

FIG. 3 is schematic block diagram of an embodiment requiring an interrogation signal to be on for only a certain time period before system wake-up is initiated; and

FIG. 4 is a more detailed schematic block diagram of the signal duration verification logic of FIG. 3.

### DETAILED DESCRIPTION OF THE PREFERRED EMBODIMENTS

The invention substantially reduces unnecessary power drain from a battery power source in a keyless entry system transponder and associated circuits thereto. The invention comprises an asymmetrical time constant low pass filter connected between an electromagnetic energy or radio frequency receiver/detector and wake-up logic which controls the connection of battery power to the keyless entry system transponder and associated circuits thereto. Another embodiment of the invention also determines the length of time a signal is present and if the signal time is within a certain time frame, a wake-up signal is then sent to wake-up the keyless entry system transponder.

Referring now to the drawings, the details of the preferred embodiment of the invention are schematically illustrated. Elements in the drawings that are the same will be represented by the same numbers, and similar elements will be represented by the same numbers with a different lower case letter suffix.

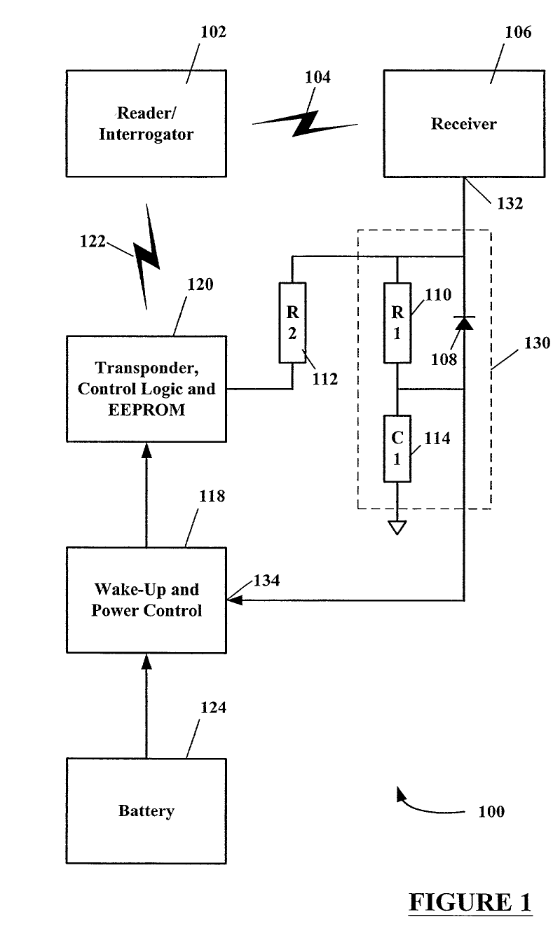

Referring now to FIG. 1, a schematic block diagram of a keyless entry system, according to an embodiment of the invention, is illustrated. A keyless entry system is generally indicated by the numeral 100. The keyless entry system 100 comprises a reader/interrogator 102, a receiver 106, an asymmetrical time constant low pass filter 130, wake-up and power control 118, a transponder and associated circuits thereto 120, and a battery 124. The receiver 106, asymmetrical time constant low pass filter 130, wake-up and power control 118, and transponder and associated circuits thereto 120 may be fabricated in one or more integrated circuit packages, and may be further integrated with the battery 124 into a small keyfob, embedded into the head of a key, made in the shape of an access card and the like.

The reader/interrogator 102 transmits an interrogation signal 104 that is received by the receiver 106. The receiver 106 is adapted to receive signals at a desired frequency and signal strength, and will receive any signal at that desired frequency plus or minus the bandwidth of tuned circuits (not illustrated) of the receiver 106. When the desired frequency interrogation signal is received by the receiver 106, the resulting detected signal at the output 132 of the receiver 106 is delayed for a desired time by the low pass filter 130 before the wake-up logic 116 detects the signal being present at its input 134. Once the desired frequency interrogation signal is present for a sufficient time period (determined by the low pass filter 130) the wake-up power control 118 connects the battery 124 to the transponder and associated circuits thereto (120).

Information in the received interrogation signal 104 is connected from the output 132, through a resistor 112, to a data input of the transponder 120. After detection and synchronization of the received interrogation signal 104, the transponder 120 transmits an acknowledgement or verification signal 122 to the reader/interrogator 102. Upon receipt of a correct verification signal 122, the reader/interrogator 102 causes a desired action to occur, such as for example, unlocking an automobile door, garage door, building entrance, opening a security gate, turning on or off lights, disarming a security system, and the like.

An embodiment of the keyless entry system 100 includes an electronic key or keyfob that can remain in a pocket or purse, and when brought into, for example, a low frequency magnetic field surrounding a vehicle (not illustrated) generated by the reader/interrogator 102, the electronics in the key or keyfob wakes up and starts communicating with the reader/interrogator 102 in the vehicle (not illustrated). Once a proper verification is detected by the reader/interrogator, the vehicle door may unlock, or even automatically open. The present invention substantially reduces false and unnecessary wake-up of the electronics in the key or keyfob and thus increases the useful battery life thereof.

The resistor 110 (R1) may preferably be about one megohm (106 ohm) and the capacitor 114 (C1) may preferably be about two nanofarads (2×10⁻⁹ farads). These values give a time constant, τ=RC, of about 2×10⁻³ seconds, or two milliseconds. This is a sufficient time delay to insure that the wake-up logic 116 is not false triggered by undesired noise signals. According to the invention, if the capacitor has not been charged for at least the time constant, τ, then the wake-up threshold has not been reached on the input 134. When there is no signal on the output 132 the voltage thereon may be less than the voltage on the capacitor 114 and input 134 after some charging of the capacitor 114. Whenever the signal voltage on the output 132 is less than the voltage on the capacitor 114, the diode 108 quickly discharges the voltage on the capacitor 114 (the diode 108 effectively shorts out the resistor 110). Therefore, if the received signal at the output 132 does not remain at the desired voltage level for at least the time constant, τ, then the wake-up threshold is never reached, and whatever voltage level happens to be present on the capacitor 114 is quickly discharged through the diode 108. Once the capacitor 114 has been discharged, the signal at the output 132 must be at a desired value for at least the time constant, τ, before the wake-up threshold at the input 134 may be reached. Thus, noise, or periodic or aperiodic nuisance signals will not activate the wake-up and power control 118.

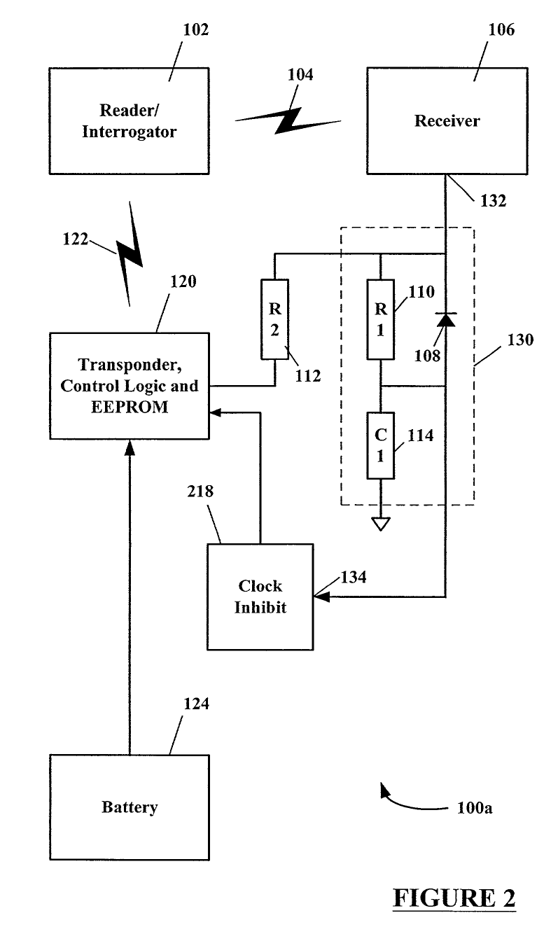

It is contemplated and within the scope of the present invention that in addition to, or in lieu of, the wake-up and power control 118, clock logic gates may be used to inhibit clocking of power consuming logic circuits which, in complementary metal oxide semiconductor (CMOS) transistor logic, effectively and substantially reduces the power drain of the circuits. Referring now to FIG. 2, a schematic block diagram of a keyless entry system, according to another embodiment of the invention, is illustrated. A keyless entry system 100a comprises the circuits of the embodiment illustrated in FIG. 1 except that the transponder and associated circuits thereto 120 are directly connected to the battery 124. A clock inhibit 218 enables and disables clock signals in the transponder and associated circuits thereto 120 so that the CMOS circuits thereof draw minimal power from the battery 124. The wake-up logic 116 controls the clock inhibit 218 in a similar fashion to the power control 118 illustrated in FIG. 1 and described herein above. When a signal is present on input 134, the wake-up and clock inhibit 218 enables the clocks in the transponder and associated circuits thereto 120, and the response signal 122 is sent to the interrogator 102.

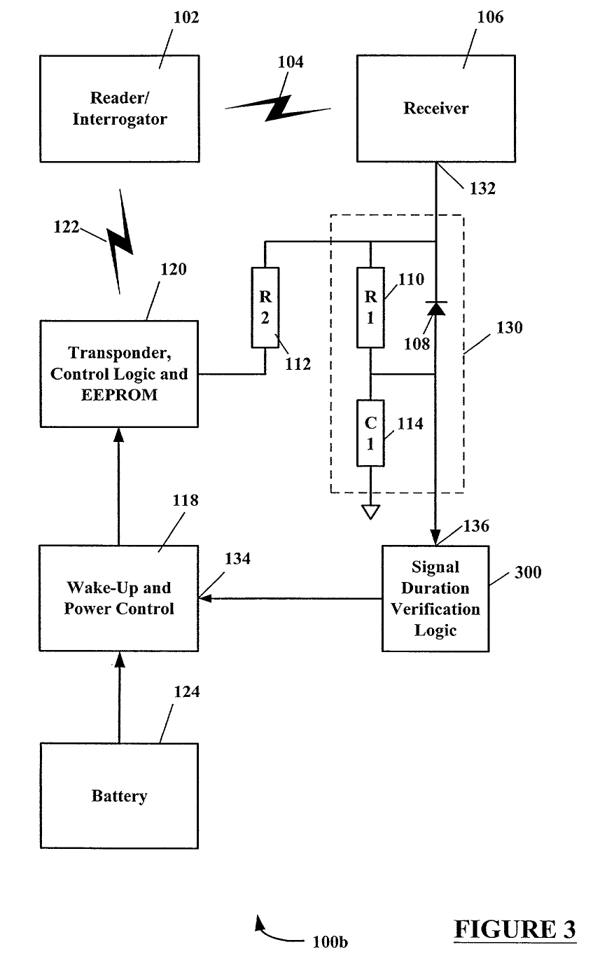

Referring to FIG. 3, a schematic block diagram of an embodiment requiring an interrogation signal to be on for only a certain time period before system wake-up is initiated is illustrated. The keyless entry system 100b comprises a reader/interrogator 102, a receiver 106, an asymmetrical time constant low pass filter 130, signal duration verification logic 300, wake-up and power control 118, a transponder and associated circuits thereto 120, and a battery 124. The keyless entry system 100b works substantially the same as the system 100 of FIG. 1, except that the signal duration verification logic 300 actuates when a signal is received from the low pass filter 130 at its input 136, and the signal duration verification logic 300 then determines if the this signal is of a certain time duration. If the signal at the input 136 stays on for an anticipated time and then turns off, the wake-up and power control 118 will be enabled at its input 134 by an output signal from the signal duration verification logic 300. If the signal at the input 136 stays on longer than it should, then the signal duration verification logic 300 will not enable the wake-up and power control 118. This embodiment of the invention prevents undesired noise signals that have sufficient energy to present a signal at the input 136, but are of such duration that they are not the desired interrogation signals.

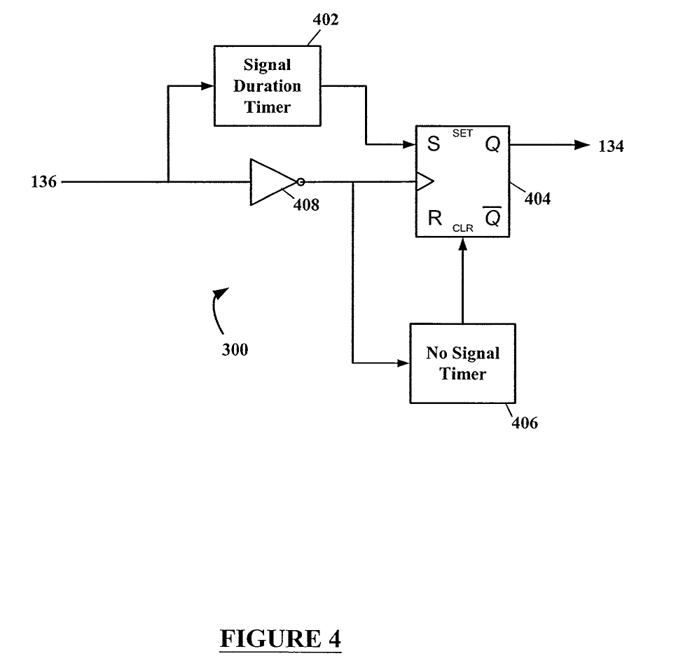

Referring not to FIG. 4, a more detailed schematic block diagram of the signal duration verification logic of FIG. 3 is illustrated. The signal duration verification logic 300 comprises a signal duration timer 402, a signal status memory such as an RS flip-flop 404, a no signal timer 406 and an inverter 408. Other logic circuits are contemplated and may be used equally and effectively under the spirit and scope of the embodiments of the present invention. The signal duration timer 402 is adapted to start a timing pulse of a duration that is slightly longer in time than the desired interrogation signal. The timer 402 starts its timing pulse when a signal is received at the input 136. The RS flip-flop 404 may be a positive edge triggered flip-flop such that when the signal is removed (logic 0) from the input 136, the inverter 408 output will be at a logic 1 and will clock the logic level at the S input of the flip-flop 404 which then retains this logic level at its Q output connected to the input 134. If the signal at the input 136 stays at a logic 1 for longer than the time period of the timer 402 (times out to a logic 0 output), then a logic zero will be loaded into the flip-flop 404 and no wake-up signal will occur at the input 134. The wake-up signal at the input 134 stays at logic 1 until no signal is received for a time period longer than the time period of the no signal timer 406. The timer 406 will time out when an input thereto (from the inverter 408) stays at a logic 1 for longer than the time period of the timer 406. This will occur when no signal is present at the input 136. A logic 0 at the CLR input of the flip-flop 404 will reset the Q output to a logic 0, thus removing the wake-up signal from the input 134.

The invention, therefore, is well adapted to carry out the objects and attain the ends and advantages mentioned, as well as others inherent therein. While the invention has been depicted, described, and is defined by reference to particular preferred embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described preferred embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A keyless entry and security system having a signal discriminator for reducing false wake-up of power consuming circuits, said system comprising:
an interrogator, said interrogator transmits an interrogation signal and listens for a response thereto;
a receiver adapted for reception of the interrogation signal, said receiver having a receiver output and producing a first signal on the receiver output when receiving the interrogation signal; and
an asymmetrical time constant low pass filter having an input connected to the receiver output, wherein a second signal is generated from an output of said asymmetrical time constant low pass filter if the first signal is present for a desired time, and if the first signal is not present for the desired time then the second signal is not generated.

2. The keyless entry and security system of claim 1, further comprising a wake-up power control circuit having a power input, power output and a control input, the control input is connected to the output of said asymmetrical time constant low pass filter, wherein power at the power input is connected to the power output when the second signal is received at the control input of said power control circuit.

3. The keyless entry and security system of claim 2, further comprising a transponder, said transponder connected to the power output and receiving power therefrom, said transponder having a data input connected to the receiver output for detecting the received interrogation signal and sending a response signal to said interrogator when power is received from the power output of said power control circuit.

4. The keyless entry and security system of claim 2, wherein the power input of said wake-up power control circuit is connected to a power source.

5. The keyless entry and security system of claim 4, wherein the power source is a battery.

6. The keyless entry and security system of claim 1, further comprising a clock inhibit circuit, said clock inhibit circuit being controlled by the second signal such that clock signals are inhibited when there is no second signal present, and the clock signals are enabled when the second signal is present.

7. The keyless entry and security system of claim 6, further comprising a transponder, said transponder connected to said clock inhibit circuit, said transponder having a data input connected to the receiver output for detecting the received interrogation signal and sending a response signal to said interrogator when the clock signals are enabled.

8. The keyless entry and security system of claim 1, wherein said asymmetrical time constant low pass filter comprises:
a resistor connected between the receiver output and the wake-up input;
a diode connected between the receiver output and the wake-up input; and
a capacitor connected between the wake-up input and a signal common.

9. The keyless entry and security system of claim 8, wherein said resistor and said capacitor determine the desired time.

10. The keyless entry and security system of claim 9, wherein said resistor is about one megohm and said capacitor is about 2×10⁻⁹ farads.

11. The keyless entry and security system of claim 10, wherein the desired time is about two milliseconds.

12. A method for reducing false wake-up of power consuming circuits in a keyless entry and security system, said method comprising the steps of:
transmitting an interrogation signal and listening for a response signal thereto;
receiving the interrogation signal and producing a first signal therefrom;
delaying the first signal with an asymmetrical time constant low pass filter for a desired time, wherein if the first signal is present for the desired time then generating a second signal;
applying power to a transponder when the second signal is generated; and
transmitting the response signal after power is applied to the transponder to acknowledge the received interrogation signal.

13. The method of claim 12, wherein the desired time is determined by a time constant of a resistor and a capacitor.

14. The method of claim 13, wherein if the first signal is not present for the desired time the resistor is bypassed with a diode so as to quickly discharge the capacitor.

15. An apparatus for reducing false wake-up of power consuming circuits in a keyless entry and security system, said apparatus comprising:
a receiver adapted for reception of an interrogation signal, said receiver having a receiver output and producing a first signal on the receiver output when receiving the interrogation signal; and
an asymmetrical time constant low pass filter having an input connected to the receiver output, wherein a second signal is generated from and output of said asymmetrical time constant low pass filter if the first signal is present for a desired time, and if the first signal is not present for the desired time then the second signal is not generated.

16. The apparatus of claim 15, further comprising a power control circuit having a power input, power output and a control input connected to the output of said asymmetrical time constant low pass filter, wherein power at the power input is connected to the power output when the second signal is received at the control input of said power control circuit.

17. The apparatus of claim 16, further comprising a transponder, said transponder connected to the power output and receiving power therefrom, said transponder having a data input connected to the receiver output for detecting the received interrogation signal and sending a response signal to said interrogator when power is received from the power output of said power control circuit.

18. The apparatus of claim 16, wherein the power input of said power control circuit is adapted for connection to a power source.

19. The apparatus of claim 15, wherein said asymmetrical time constant low pass filter comprises:
a resistor connected between the receiver output and the wake-up input;
a diode connected between the receiver output and the wake-up input; and
a capacitor connected between the wake-up input and a signal common.

20. The keyless entry and security system of claim 1, further comprising signal duration verification logic connected to the output of said asymmetrical time constant low pass filter, wherein the second signal must be less than a certain time before a third signal is generated at an output of said signal duration verification logic.

21. The keyless entry and security system of claim 20, further comprising a wake-up power control circuit having a power input, power output and a control input, the control input is connected to the output of said signal duration verification logic, wherein power at the power input is connected to the power output when the third signal is received at the control input of said power control circuit.

22. The keyless entry and security system of claim 20, further comprising a clock inhibit circuit, said clock inhibit circuit being controlled by the third signal such that clock signals are inhibited when there is no third signal present, and the clock signals are enabled when the third signal is present.

23. The keyless entry and security system of claim 20, wherein said signal duration verification logic comprises:
a signal duration timer;
a no signal timer; and
a signal status memory,
wherein the second signal starts the signal duration timer and resets the no signal timer such that when the second signal is not present and the signal duration timer has not timed out then the signal status memory is set to produce the third signal, if the second signal is present when the signal duration timer times out then the signal status memory does not to produce the third signal, and if there is no second signal when the no signal timer times out then the signal status memory is reset so that no third signal is produced.

24. The method of claim 12, further comprising the step of verifying that the duration of the second signal is less than a certain time before transmitting the response signal.

25. The method of claim 24, wherein the step of verifying that the duration of the second signal is less than a certain time comprises the steps of:
starting a signal duration timer when the second signal is asserted;
resetting a no signal timer when the second signal is asserted; and
generating a third signal when the second signal is not present and the signal duration timer has not timed out, otherwise not generating the third signal; and
resetting the third signal when there is no second signal and the no signal timer has timed out.

26. The apparatus of claim 16, further comprising signal duration verification logic connected to the output of said asymmetrical time constant low pass filter, wherein the second signal must be less than a certain time before a third signal is generated at an output of said signal duration verification logic.

27. The apparatus of claim 26, further comprising a wake-up power control circuit having a power input, power output and a control input, the control input is connected to the output of said signal duration verification logic, wherein power at the power input is connected to the power output when the third signal is received at the control input of said power control circuit.

28. The apparatus of claim 26, further comprising a clock inhibit circuit, said clock inhibit circuit being controlled by the third signal such that clock signals are inhibited when there is no third signal present, and the clock signals are enabled when the third signal is present.

29. The apparatus of claim 26, wherein said signal duration verification logic comprises:
a signal duration timer;
a no signal timer; and
a signal status memory,
wherein the second signal starts the signal duration timer and resets the no signal timer such that when the second signal is not present and the signal duration timer has not timed out then the signal status memory is set to produce the third signal, if the second signal is present when the signal duration timer times out then the signal status memory does not to produce the third signal, and if there is no second signal when the no signal timer times out then the signal status memory is reset so that no third signal is produced.
